(19) United States
(12) Patent Application Publication
(10) Pub. No.: US 2014/0058822 A1
(43) Pub. Date: Feb. 27, 2014

(54) METHOD AND APPARATUS PERTAINING TO AN AUTOMATED CONSUMER-INTERACTION EXPERIENCE

(71) Applicants: Brian J. Sobecks, Glenview, IL (US); Jeffrey Michael Deutch, Buffalo Grove, IL (US); Thomas Michael O'keefe, Grayslake, IL (US)

(72) Inventors: Brian J. Sobecks, Glenview, IL (US); Jeffrey Michael Deutch, Buffalo Grove, IL (US); Thomas Michael O'keefe, Grayslake, IL (US)

(21) Appl. No.: 14/006,410

(22) PCT Filed: Mar. 20, 2012
(86) PCT No.: PCT/US12/29781

§ 371 Date: Nov. 5, 2013

Related U.S. Application Data
(60) Provisional application No. 61/466,676, filed on Mar. 23, 2011.

(51) Int. Cl. G06Q 30/02; G06Q 50/00

(52) U.S. Cl. CPC G06Q 30/0237; G06Q 50/01
USPC 705/14.37

(57) ABSTRACT

A consumer-interaction kiosk features one or more displays (which can comprise touchscreen displays if desired) and a control circuit that operably couples to that display (or displays). Such a kiosk can be located, for example, proximal to or within a retail venue (such as, but not limited to, a grocery store or grocery department of a department or discount store). The content displayed by the kiosk can vary with the needs of the application setting but can include, for example, consumer-attraction content, information-gathering facilitation content, delivered-information content, entertainment content, and so forth. Such a kiosk can also be configured, if desired, to vend for-sale or free consumables (such as free product samples).

### RELATED APPLICATIONS

This application claims the benefit of U.S. Provisional application No. 61/466,676, filed Mar. 23, 2011, which is incorporated by reference in its entirety herein.

This application is related to co-pending and co-owned U.S. patent application Ser. No. 12/759,189, entitled Display-Based Vending Apparatus and Method and filed Apr. 13, 2010, which is incorporated by reference in its entirety herein.

### TECHNICAL FIELD

This invention relates generally to vending machines.

### BACKGROUND

Automated-consumer experiences are known in the art. Automated teller machines, for example, permit a consumer to withdraw money from (or deposit money to) their bank accounts without interacting (at least in real time) with a bank teller. Vending machines, as another example, permit a consumer to purchase and immediately receive a particular commodity without interacting with a counterpart person.

Although known approaches in these regards serve many useful purposes, there nevertheless remain numerous application settings where existing solutions are simply insufficient to facilitate an appropriate level of interaction and service. This, in turn, leads to under-served consumers and unleveraged opportunities for those seeking to engage and influence such consumers.

### BRIEF DESCRIPTION OF THE DRAWINGS

The above needs are at least partially met through provision of the method and apparatus pertaining to an automated consumer-interaction experience described in the following detailed description, particularly when studied in conjunction with the drawings, wherein:

FIG. 1 comprises a block diagram as configured in accordance with various embodiments of the invention;

FIG. 2 comprises a schematic front-elevational view as configured in accordance with various embodiments of the invention;

FIG. 3 comprises a schematic front-elevational view as configured in accordance with various embodiments of the invention;

FIG. 4 comprises a schematic front-elevational view as configured in accordance with various embodiments of the invention; and

FIG. 5 comprises a schematic top-plan view as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to Improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand, that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a consumer-interaction kiosk features one or more displays (which can comprise touch-screen displays if desired) and a control circuit that operably couples to that display (or displays). Such a kiosk can be located, for example, proximal to or within a retail venue (such as, but not limited to, a grocery store or grocery department of a department or discount store). The content displayed by the kiosk can vary with the needs of the application setting bat can include, for example, consumer-attraction content, information-gathering facilitation content, delivered-information content, entertainment content, and so forth. Such a kiosk can also be configured, if desired, to vend for-sale or free consumables (such as free product samples).

By one approach, the aforementioned control circuit can be easily and regularly reprogrammed to accommodate new information, promotions, consumables, or the like. If desired, this control circuit can be coupled via one or more facilitating networks (and/or direct connections) to social-networking services, consumer end-user platforms (such as so-called Smartphones), one or more servers, databases, or the like as pertain to the retail venue hosting the kiosk, and so forth to thereby facilitate geographic and/or content-based extensions of its supported interactions.

Pursuant to these teachings, such a kiosk can serve to introduce consumers to new opportunities and to further enrich and/or maintain a consumer's appreciation of and relationship with a given manufacturer and/or distributor. These teachings can also serve to greatly leverage a given consumer-interaction opportunity to deepen a consumer's awareness of the sponsor's product line and thereby encourage loyalty and product usage.

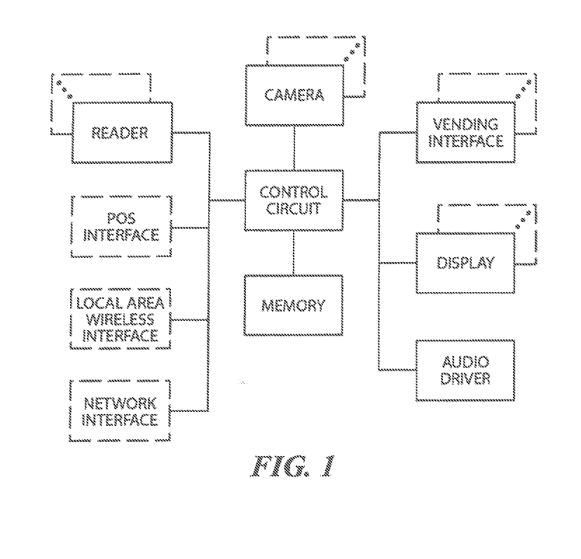

These and other benefits may become clearer upon making a thorough review and study of the following detailed description. Referring now to the drawings, and in particular to FIG. 1, an illustrative process that is compatible with many of these teachings will now be presented.

In this illustrative example, the consumer-interaction kiosk comprises a control circuit that operatively couples to a memory and one or more displays. This control circuit can comprise a fixed-purpose platform (such as a so-called hard-wired platform) or can comprise a partially or wholly programmable platform. When programmable, the aforementioned memory can serve, at least in part, to contain some or all of the computer instructions that, when executed by the control circuit, effect one or more of the steps, actions, and/or functions described herein. The display can comprise, for example, a flat-screen display (either full-color or monochromatic as desired) where the display is mounted on or within a kiosk housing so as to be readily viewable by a person of ordinary stature when standing. This might comprise, by one approach, configuring the display such that its longer dimension is vertically oriented.

By one approach, one or more of the displays can comprise, in whole or in part, touch-screen displays. So configured a consumer can input responses or other instructions by touching (or appearing to touch) the display. Various touch-screen methodologies are known in the art. As these teachings are not particularly sensitive to any particular selections in these regards, further elaboration here regarding such methodologies will not be presented.

By one approach, the consumer-interaction kiosk can also comprise one or more audio drivers (and corresponding audio transducers) as desired. This can serve to facilitate the rendering of audio content, either in synchronicity with displayed content or otherwise as desired.

By one approach, the aforementioned control circuit can also operatively couple to a vending interface or interfaces as desired. This vending interface can be configured to permit the kiosk to vend one or more items to a consumer on a for-sale basis or, if desired, as a free sample. When operating as a free-sample distribution platform such a kiosk can serve to either complement other in-store sampling practices or compete and replace such practices.

By one approach, the kiosk can be provisioned with only one vendible commodity. By another approach, the kiosk can be provisioned with a plurality of different, selectable vendible commodities. This can include edible items such as, but not limited to, wrapped (or unwrapped), shelf-stable or refrigerated (or even frozen) food items). Such a kiosk can also serve, if desired, to hold and selectively offer promotional premiums in a controlled and secure manner. So configured, both the storage of such premiums and their manner of distribution can be suitably controlled to help to ensure that the intentions of the promotion are met.

The vendible-commodities storage area of the kiosk can be configured as appropriate to suit short or long-term storage of those commodities. For example, by one approach, the storage area, can be refrigerated and/or heated as desired and as appropriate to the retention of those commodities.

Also, as desired, such a kiosk can be configured to process a vendible item prior to vending that item to a consumer. This might comprise, for example, selectively heating one or more vendible items before providing that item to the consumer. As another example in these regards, such a kiosk can be configured to prepare and dispense beverages, including free samples that are prepared pursuant to a consumer's expressed individual choices (regarding, for example, such parameters as temperature, liquids, powders, flavors, nutraceuticals, and so forth).

By one approach, the stocking of such a vending/sampling capability (in conjunction with selective corresponding re-skinning of the interface and/or variations to the substantive content being conveyed) can be coordinated with the enterprise that physically hosts the kiosk. For example, a grocery store that hosts such a machine could be offered the opportunity to move excess inventory via an in-store sampling offering.

When one or more of the vendible items is provided on a for-sale basis, the kiosk can further optionally comprise a point-of-sale (POS) interface that also operably couples to the control circuit. So configured, the point of sale interface can serve to receive currency and/or coins from the consumer and/or can be configured to receive and/or otherwise read, for example, a credit or debit card. Other point-of-sale interfaces are known in the art or may be developed in the future. As these teachings are not particularly sensitive to any particular selection in these regards, further elaboration will not be provided here.

These teachings will further accommodate operably coupling one or more cameras to the control circuit. These can comprise a video camera and/or a still image camera. The camera can be oriented such that its field of view is likely to include a consumer (or consumers) having a stature within, an expected range of statures who is positioned with respect to the kiosk in a way that suggests a desire to interact with the kiosk.

By one approach, the control circuit can be configured to process camera-captured images in order to detect the presence of such a consumer. By another approach, in lieu of the foregoing or combined therewith, the kiosk can further include one or more proximity sensors (such as, but not limited to, a passive-infrared (PIR) sensor) (not shown) to thereby facilitate the detection of an available consumer. This camera can have a fixed field of view if desired. These teachings will also accommodate, however, having selectively adjustable focus, pan, tilt, and/or zoom. By one approach, such parameters can be automatically varied, by the control circuit (or can comprise a native capability of the camera itself) to facilitate best capturing the consumer's visage.

By one approach, these teachings wilt also accommodate configuring such a kiosk to include one or more readers that operably couple to the aforementioned control circuit. By one approach, such a reader can comprise a magnetic strip reader to thereby facilitate reading, for example the encoded data on a frequent-purchaser/loyalty card as issued and maintained by the retail venue that hosts the kiosk. As another example in these regards, but again without intending any limitations in these regards, such a reader can comprise a radio-frequency identification (RFID) tag reader to read one or more RFID tags as may be carried by the consumer and utilized for identification, credit, debit, and/or other consumer-interaction transactions and experiences.

If desired, such a kiosk can also he configured to solicit and gather permission-based consumer information (either via direct entry from the consumer and/or as inferred from observed consumer behaviors). Such information can be stored or conveyed to a remote location and in any event can serve to inform improved consumer relationships, marketing, and consumer bonding services.

If desired, this kiosk can comprise a substantially stand-alone platform. If desired, however, this kiosk can be configured to interact locally or remotely with other resources, servers, and entities. This might comprise, for example, operably coupling the control circuit to a local area wireless interface (such as hut not limited to a Bluetooth-compatible interface), a so-called WIFI interface (supporting one or more 802.11(x)-compatible protocols), or the like. So configured, the control circuit could communicate with, for example, a Bluetooth or WIFI-enabled Smartphone, personal digital assistant, laptop computer, tablet computer, or the like as carried and utilized by a consumer who is otherwise interacting with the kiosk.

Along these same lines, the control circuit can operably couple to one or more other kinds of network interfaces. So configured, the kiosk could have access to, for example, an extranet such as the Internet. By another approach, in lieu of the foregoing or in combination therewith, such a network interface could permit the control circuit of the kiosk to interact with one or more in-facility servers, databases, or other network elements as comprise a part of a private network serving the retail venue that hosts the kiosk. Generally speaking, such a kiosk could be configured to operate in a stand-alone mode or could tie-in as desired with any number of other services including, for example, retail media networks and other out-of-home network.

Such a kiosk can also be configured to leverage any available location-based information and services (obtained via, for example, Foursquare, Loopt, mesh networks, the consumer's location-capable telephony device, or the like). Such information could serve, for example, to further influence the particular substantive information being provided to specific or general customers as a function of geographic location.

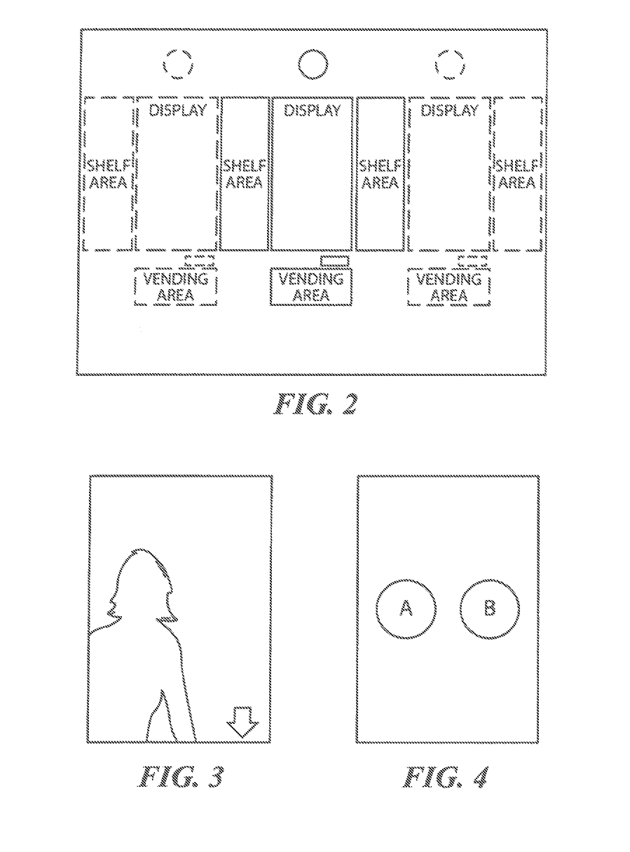

Referring now to FIG. 2, such a kiosk can comprise an integral or multi-part housing to contain and otherwise support the aforementioned components. As noted earlier, the display for such a kiosk can be oriented with its longer dimension being vertically positioned if desired. Also as noted earlier, such a kiosk can comprise a plurality of displays if desired. In the particular illustrative example shown, and without intending any limitations in these regards, such a kiosk can be configured to accommodate one or more consumer-interaction stations (with three such stations being shown in FIG. 2), In this illustrative example, a vending area is positioned beneath each primary display to permit providing vendible items to a consumer at that particular station. A card reader is disposed between that vending area and each display to penult, for example, reading a consumer's loyalty card or the like. This illustrative example also depicts cameras located above each display and being oriented to include the consumer who occupies that respective station area.

By one approach, if desired, such a kiosk housing can include one or more shelf areas. In this particular illustrative example, shelf areas are located on either side of each of the displays. These shelf areas can serve to stock and present one or more items that the consumer can select for later purchase.

Such a kiosk housing can be comprised of any suitable material or materials including various metals, plastics, and natural materials such as wood, or the like. The dimensions of the kiosk can be selected to occupy as little or as much space as may be appropriate to suit the needs and/or opportunities as tend to characterize a given application setting.

As noted earlier, the display for such kiosk can present varying kinds of content. This content can be identical at a given moment in time for each display (for example, when each display is presenting content intended to attract a consumer to the kiosk). It is also possible for each display to be presenting different content. This can be particularly appropriate, for example, when a different consumer is present at each of the consumer-interaction stations.

As but one simple example in these regards, and referring momentarily to FIG. 3, such a display can present the image of a person and/or an avatar of choice to engage and otherwise interact with a consumer in an intuitive and natural way. Other graphic content can be utilized as appropriate to facilitate other purposes. For example, in the simple example shown, a downward-oriented arrow in the lower right-hand corner can serve to direct the consumer's attention to the loyalty-card reader that is disposed beneath the display proximal that area.

Also as noted above, one or more of these displays can comprise a touch-screen display. As a simple illustrative example in these regards, and referring now momentarily to FIG. 4, such a touch-screen display can serve to permit a consumer to intuitively select from amongst a plurality of choices. For example, in FIG. 4 the consumer can choose between Option A and Option B by simply touching the display in the corresponding area of the display.

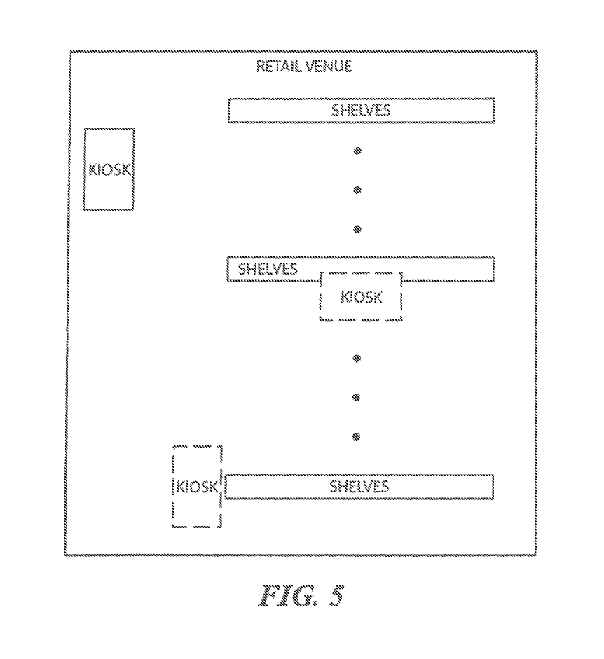

As noted above, such a kiosk can be located, if desired, within a retail venue as generally illustrated in FIG. 5. The kiosk may, or may not, contain content and otherwise serve the purposes of a sponsor that is the same as, or different than, the operator of the retail venue. For example, the retail venue may he operated by a grocery-store operator whereas the kiosk is sponsored by, at least primarily, a manufacturer of one or more grocery items. It is also possible for the kiosk to be co-sponsored by both such a manufacturer and a retail-venue operator as desired. (Those skilled in the art will appreciate that these teachings can be applied in non-traditional settings other than retail venues. Possible alternative venues comprise, but are not limited to, travel stations and depots (such as airports, bus stations and bus stops, train stations, and so forth.)

By one approach, such a kiosk can be located away from the primary display of the venue's items that are offered for sale. This might comprise locating the kiosk, for example, near the front of the store (for example, proximal to a service desk or the like). These teachings will accommodate other locations as well, however. For example, in lieu of the foregoing or in combination therewith, such a kiosk can be located in the primary product display areas (for example, either presented in front of or otherwise Integrally within shelving units) or as an end-cap display.

So configured, such a kiosk can be configured to carry out any of a number of useful consumer-experience interactions. Some illustrative examples will now be provided. Those skilled in the art will understand that these examples are not intended to suggest limitations in these regards by their specificity or details.

Such a kiosk can be configured to operate in an attraction mode in the absence of any consumers having presented themselves at one or more aforementioned stations. This can comprise presenting graphic content via the display, audio content, or both. The rendered information can be, for example, general information intended to attract the eye and/or ear of passers-by and bearing substantive content likely to engage the curiosity or interest of such passers-by. Such content can be looped to permit appropriate repetition of foe content unless and until the interest of the consumer is engaged. These teachings will of course accommodate having two or more attract loops such that the content can be sequentially or randomly varied to thereby perhaps increase the chance of successfully attracting a consumer's interest.

There are various ways by which such a kiosk can conclude such an attract mode and begin an interaction mode. By one approach, for example, the consumer can simply touch the display in order to indicate their presence and interest. By another approach, the presence of the consumer can be detected automatically and the corresponding interaction mode initiated.

The use of a camera to capture the image of an interested consumer can be leveraged, if desired, to permit the automated determination of the consumer's general age and gender. This information, when available, can be utilized to select the content provided to the consumer and/or the manner in which that content is delivered. For example, an adult avatar may be displayed when interacting with a middle-aged person while an animated cartoon character might be utilized when interacting with a child. Such information can also be utilized to select specific content to be displayed. For example, demographically-based offerings can be automatically selected to match the perceived demographics of the interested consumer.

Such analytics regarding age and/or gender can also be stored by the control circuit and/or forwarded on to a remote server for further analysis as desired. This, in turn, can be leveraged to better understand which attraction modes are attracting a particular demographic, which optional selections tend to be further investigated by particular demographic groups, and so forth. This, in turn, can help to facilitate better future interactions with consumers and assure the delivery of desired content by these interested parties.

As noted above, if desired, the aforementioned kiosk can interact with, for example a consumer's Smartphone. In this case, the kiosk could, for example, locate a shopping list in the consumer's Smartphone and present the consumer with an option of reviewing recipes that tend to correspond to items on that shopping list. This could comprise permitting the consumer, for example, to select from various groupings of recipes (such as, but not limited to, three-ingredient meals, quick meals, healthy meals, and so forth). When the consumer selects a particular recipe, these teachings would then accommodate, if desired, transmitting or otherwise forwarding that recipe to the consumer's Smartphone or to such other location (such as a home-computer address) as might be specified by the consumer.

Upon selecting a particular recipe, the kiosk could then offer to the consumer the service of updating the consumer's shopping list to include any missing ingredients that might be required to practice the selected recipe.

These teachings will accommodate other, simpler meal-planning approaches as desired. For example, the kiosk can offer the consumer an opportunity to do recipe searching without relying upon a pre-provisioned shopping list if desired. Upon selecting one or more recipes in this way, the kiosk could again, if desired, forward, the corresponding recipe information and/or corresponding shopping list to the consumer's platform of choice.

Another option, if desired, would be to provide the kiosk (either integrally or locally) with a printing capability. This would permit the kiosk to provide the consumer with a hard-copy version of the selected recipes and/or shopping list for corresponding ingredients, proffered coupons, rebate forms, and so forth.

As suggested above, the kiosk can be provided with a capability of receiving information regarding the consumer's belonging to a loyalty program for the retail venue that hosts the kiosk. This information, when available, could be utilized to aid in specifically identifying the consumer and this, in turn, could be utilized to further personalize the interaction. As one simple example in these regards, the purchasing history of this particular consumer could be assessed and specific recipes could be suggested that presume the consumer's interest in such products and/or their ready availability to the consumer. As another example, this information could be utilized to facilitate providing the consumer with corresponding discount offerings, rebate offerings, or other promotional opportunities. By one approach, such promotional discounts could be automatically added to their loyalty account and to facilitate their automatic redemption at the time of checking out. By another approach, such opportunities could be wirelessly provided to the consumer's portable electronic device of choice (such as their Smartphone) as an electronic coupon that can be redeemed upon checking out.

As noted above, by one approach, the kiosk can be configured to vend one or more items to an interested consumer. This can comprise providing the consumer with one or more free samples. The particular samples provided, or the number of samples provided, can be made dependent, if desired, upon having particular kinds of information available regarding the consumer. For example, when the consumer is sufficiently known to the system (for example, via their long-standing status as a frequent visitor of the retail venue that hosts the kiosk) it may be appropriate to provide higher-grade samples and/or a greater number of samples to such a person.

The samples themselves can be general in nature or can specifically tie in, for example, to one or more of the recipes being suggested to a particular consumer. For example, when a given recipe calls for a particular ingredient the kiosk can, while presenting information to that consumer about that recipe, also provide that consumer with an opportunity to have a corresponding free sample of that particular ingredient. Upon receiving an affirmative indication from the consumer, the kiosk could then immediately automatically vend the free sample to the consumer. The consumer could then base subsequent selections and actions upon a real-time assessment of that sample.

Such a kiosk can also serve, in lieu of the foregoing or in combination therewith, to distribute (with or without monetary compensation) soft goods such as, but not limited to, mobile services, on-line consumer services (such as an Internet-facilitated food assistant application, health and wellness services, food pairing services, party and event planning services, dieting services, and so forth), and digital media of various kinds (including but not limited to audio content, video content, textual content, graphic content, and so forth). These teachings can support the foregoing in isolation or, if desired, in combination with the promotion and/or sale of one or more (possibly inter-related) consumer products.

The particular recipes and ingredients suggested of course opens the opportunity for cross-merchandising as desired. This might comprise, for example, permitting two manufacturers of differing grocery items to present recipes, content, samples, and the like to encourage learning about and ultimately purchasing items from both of their product lines.

So configured, such a consumer-interaction kiosk can be readily re-skinned to better suit a variety of seasons, sales opportunities, and so forth. With this in mind, such a capability can be further facilitated by decoupling the presentation layer from the user interface to thereby readily enable a relatively fast and simple ability to change and thereby refresh the creative content and corresponding digital assets for a given kiosk. Such a kiosk can be particularly useful with respect to promotional tie-ins corresponding to so-called tent-pole events (such as Super Bowl weekend, Thanksgiving, Independence Day barbeques and picnics, and so forth). In particular, the images displayed and the audio sounds rendered can specifically tie in thematically with such an event, as can the particular ingredients and/or recipes being offered.

If desired, such re-skinning can be temporally based. For example, the appearance (and/or content, as desired) of the kiosk can be varied as a function of time (including time of day and/or day of the week) to better suit the marketing opportunities represented by general consumer differences that might be evident on a predictable temporal basis. This re-skinning capability can also serve to enable broadcasting to a general audience as well as narrowcasting to a smaller audience (down, to and including a single given consumer).

Such a kiosk can also be configured to offer entertainment to engage the interest and imagination of a visiting consumer. This can range from simple promotions (such as instant-win sweepstakes) to more-complicated promotions such as recipe-based games and other activities. This can include the use of personalized avatars or other backgrounds or components of the displayed interaction (customized by the consumer or not as desired), mobile tagging (including, for example, QR codes, DataMatrix codes, Microsoft Tags, geo-tagging, and so forth), augmented reality, and so forth.

As one specific but non-limiting example In these regards, the kiosk's camera can be utilized to capture the consumer's face. This image (perhaps appropriately and automatically cropped) can then be combined with other imagery In an entertaining manner. For example, the consumer's face can be superimposed on a virtual bobble-head doll with the doll's head then being animated in a hobbling manner for the amusement of the viewer. As another example, and as perhaps apropos to a Super Bowl weekend tent-pole promotion, the consumer's face can be placed within a football helmet for their football team of choice. The resultant image can then be displayed, again for the enjoyment of the onlooker. These teachings would also support transmitting such images to any destination of choice as identified by the consumer (such as their Smartphone, a home or friend's e-mail address, or the like).

If desired, pattern-recognition programming could be utilized to detect inappropriate (for example, obscene) gestures or the like when practicing such functionality. Upon detecting such content, an appropriate corresponding action could automatically follow. This might comprise, for example, questioning whether the consumer in fact intends to utilize the captured image as is, or simply halting the process and denying further display, use, forwarding, or other manipulation of the captured image.

As alluded to earlier, such a kiosk can also be lightly or tightly interconnected with a social network of choice. For example, it might be possible to host the identity of this particular kiosk at a site such as Facebook. Interested consumers could then “friend” the kiosk and obtain enhanced interaction opportunities available via that social networking capability. As one simple example, a consumer who selects a particular recipe at the kiosk can have that recipe posted and rated at either their own Facebook page or at the Facebook page for the kiosk. As another example in these regards, contests can be conducted via the social, networking site to interest the consumer in making repeat visits to the kiosk. For example, one such opportunity might comprise asking the kiosk's friends to vote on which of a plurality of candidate free samples should in fact be offered at the kiosk at a particular point in time. Having the opportunity to vote in this regard and to become interested in and vested in the outcome can be both entertaining and engaging to the consumer while also helping to foster the consumer's motivation to revisit that particular kiosk and the retail venue that hosts the kiosk.

As a more specific but non-limiting example in these regards, such a kiosk could, during the course of a “face-to-face” interaction with a consumer, prompt that consumer to initiate and/or complete one or more social network actions. This might comprise, for example, prompting the consumer to “friend” a particular social-network entity (such as the kiosk itself or a sponsoring entity such as a manufacturer and distributor of a given line of products) at a site such, as Facebook, to “follow” a particular social-network entity at a site such as Twitter, or to “check-in” at a site such a Foursquare, to note but a few current examples in these regards.

By one approach, to prompt the consumer into taking such an action the kiosk can hold out the offer of a promotional opportunity in exchange for the consumer immediately acting in these regards (using, for example, a web-enabled smart phone). This might comprise, for example, providing to the consumer a discount or rebate coupon (in hardcopy or virtual form as desired), a voucher (again in hardcopy or virtual form, as desired) that can be exchanged for a free item at another location, or an immediately-proffered free sample of choice (that the kiosk is capable of presently vending (such as a food item, a drink, a non-edible physical object, a digital object (such as a. song, video, or the like), and so forth).

When providing something of value to the consumer for taking some desired action with a particular social network, of course, it may be appropriate to take precautions to avoid a potential abuse of such an opportunity by an overly-aggressive consumer. As one example in these regards, the consumer may be provided with a code upon completing the instructed action. This might be, for example, an alphanumeric code that is texted to their phone. As another example, this might comprise a two-dimensional optical code that the consumer receives at their communications device as a graphics file (such as a .tif or .jpg-formatted file).

Upon receipt, the consumer could then provide this code to the kiosk to prove the completion of their action and to trigger the provision of the aforementioned consideration (such as a free sample). These teachings will accommodate any of a variety of ways of providing this code to the kiosk. By one approach, the kiosk could have a tactile user interface (such as a real or virtual keyboard or keypad) that the consumer can utilize to enter the code value. By another approach (for use when, for example, the code has the form of a two-dimensional code that the consumer can present on the display of their smart phone), the kiosk can have a seamier or camera that can view a proffered code.

There are numerous ways by which a social network-based relationship with such a consumer can be leveraged to advantage of all parties concerned. As but one example in these regards, promotional content could be placed, on the “wall” of a “friended” consumer in Facebook. In addition to providing information and other consumer relationship development content in this manner, this promotional content could also offer limited-time discount offers to the other friends of the consumer to extend.

As a further related embellishment in these regards, it would be possible to provide a smart phone application (such as an iPhone or Droid “app”) that would facilitate permitting a consumer to very rapidly accomplish such actions in a very short period of time to thereby permit the consumer to more quickly receive, for example, a free sample that they desire. Such an application might be provided by, say, a large manufacturer of a large and varied line of products and could serve to Interact in a relatively transparent manner with various kiosks as might be fielded by such a manufacturer. Such an application, of course, could comprise a location-aware application. In such a case, the application could serve to provide notice to the consumer about where kiosk-interaction opportunities might be available to the consumer given their present location along with information about the type of kiosk-interaction opportunity.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

As one illustrative example in these regards, such a kiosk can be configured to permit a given consumer to arrange to recommend and even reserve a particular free sample to one or more friends via corresponding texts, emails, tweets, or the like. Such a recommendation could include information regarding the location of the kiosk along with a unique code that the friend could enter or otherwise present at some future time, either at this kiosk or another, to receive that particular sample.

In a related approach, the consumer could be permitted to select a particular vendable item and to pay for that item on behalf of their Identified friend. That friend could then, at some future time and upon presenting themselves at the kiosk, claim that reserved and pre-paid item.

As another illustrative example in these regards, a large number of fielded kiosks could, receive, from a central location, such information as meal-planning solutions such that all such fielded kiosks could have the benefit of such information regardless of their present location or when last serviced by visiting personnel. All (or specifically targeted) kiosks could also receive selection criteria from a remote facility in help individual kiosks better inform local decisions regarding which meal-planning solutions to offer and under what circumstances (including geographically-based sensibilities, temporally-based sensibilities, host-facility-based sensibilities, retail-channel-based sensibilities, and so forth). Such a centralized (or at least networked) architecture could also serve to facilitate regular system operational health, predictive maintenance, product inventory monitoring and tracking, and so forth.

And as yet a further illustrative example in these regards, the kiosk's housing can itself be configured to support flexible reconfigurations to suit various needs. This can include adopting a modular approach to the housing to permit a variable number of consumer interaction stations to be selectable and supportable, using a flexible shelving approach to permit on-site adjustments to support products having different form factors and sizes, and so forth.

We claim:

1. A consumer-interaction kiosk comprising:
a display:
a control circuit operably coupled to the display, the control circuit being configured to, during a face-to-face interaction with a consumer:
prompting the consumer to engage in a particular social network action;
confirming that the consumer engaged in the particular social network action;
upon confirming that the consumer engaged in the particular social network action, rewarding the consumer with a promotional opportunity.

2. The consumer-interaction kiosk of claim I wherein the particular social network action comprises friending a particular social-network entity.

3. The consumer-interaction kiosk of claim 2 wherein the particular social-network entity comprises the consumer-interaction kiosk.

4. The consumer-interaction kiosk of claim 2 wherein the particular social-network entity comprises an entity that sponsors the consumer-interaction kiosk.

5. The consumer-interaction kiosk of claim 1 wherein the particular social network action comprises following a particular social-network entity.

6. The consumer-interaction kiosk of claim 5 wherein the particular social-network entity comprises at least one of the consumer-interaction kiosk and an entity that sponsors the consumer-interaction kiosk.

7. The consumer-interaction kiosk of claim 1 wherein prompting the consumer to engage in a particular social network action comprises prompting the consumer to engage in the particular social network action via a web-enabled smart phone.

8. The consumer-interaction kiosk of claim 1 wherein the promotional opportunity comprises providing to the consumer at least one of a discount and a rebate coupon.

9. The consumer-interaction kiosk of claim 8 wherein the coupon comprises at least one of a hardcopy coupon and a virtual coupon.

10. The consumer-interaction kiosk of claim 1 wherein the promotional opportunity comprises a voucher that is exchangeable for a free item.

11. The consumer-interaction kiosk of claim 10 wherein the voucher comprises at least one of a hardcopy voucher and a virtual voucher.

12. The consumer-interaction kiosk of claim 10 wherein the voucher is exchangeable for a free item at a location other than a location that hosts the consumer-interaction kiosk.

13. The consumer-interaction kiosk of claim 1 wherein the promotional opportunity comprises an immediately-proffered free sample.

14. The consumer-interaction kiosk of claim 13 wherein the consumer-interaction kiosk is itself configured to vend the immediately-proffered free sample.

15. The consumer-interaction kiosk of claim 13 wherein the control circuit is further configured to permit the consumer to select a particular free sample to receive.

16. The consumer-interaction kiosk of claim 1 wherein confirming that the consumer engaged in the particular social network action comprises receiving an action-verification code from the consumer.

17. The consumer-interaction kiosk of claim 16 wherein receiving an action-verification code from the consumer comprises receiving the action-verification code via a tactile user interface.

18. The consumer-interaction kiosk of claim 16 wherein receiving an action-verification code from the consumer comprises receiving the action-verification code via an image-capture input.

19. The consumer-interaction kiosk of claim 18 wherein receiving the action-verification code via an image-capture input comprises receiving an image of a two-dimensional code.

20. The consumer-interaction kiosk of claim 16 wherein receiving an action-verification code from the consumer comprises receiving an action-verification code from the consumer that the consumer receives from a social-network site in exchange for engaging in the particular social network action.
